(19) United States
(12) Patent Application Publication
(10) Pub. No.: US 2018/0183271 A1
(43) Pub. Date: Jun. 28, 2018

(54) NON-CONTACT POWER FEEDING DEVICE

(71) Applicant: OMRON Corporation, Kyoto-shi (JP)

(72) Inventor: Goro NAKAO, Inazawa-shi (JP)

(73) Assignee: OMRON Corporation, Kyoto-shi (JP)

(21) Appl. No.: 15/894,998

(22) Filed: Feb. 13, 2018

Related U.S. Application Data
(63) Continuation of application No. PCT/JP2016/081015, filed on Oct. 19, 2016.

(30) Foreign Application Priority Data
Nov. 30, 2015 (JP) 2015-233527

(51) Int. Cl. H02J 50/12

(52) U.S. Cl. CPC H02J 50/12

(57) ABSTRACT

A non-contact power feeding device has a power transmission device and a power reception device having a receiving coil to which power is transmitted in a non-contact manner from the power transmission device. The power transmission device has a resonant circuit and a power supply circuit. The resonant circuit has a capacitor and a transmitting coil connected to one end of the capacitor and configured to perform power transmission with the receiving coil. Also, the power supply circuit is configured to supply AC power having an adjustable operating frequency to the resonant circuit. Furthermore, the power transmission device has a voltage detection circuit configured to detect an AC voltage applied to the transmitting coil and a control circuit configured to adjust the operating frequency of the AC power supplied from the power supply circuit in a direction in which the AC voltage increases.

### CROSS REFERENCE TO RELATED APPLICATIONS

This application is a continuation application of International Application No. PCT/JP2016/081015, filed on Oct. 19, 2016, which claims priority based on the Article 8 of Patent Cooperation Treaty from prior Japanese Patent Application No. 2015-233527, filed on Nov. 30, 2015, the entire contents of which are incorporated herein by reference.

### TECHNICAL FIELD

The disclosure relates to a non-contact power feeding device.

### RELATED ART

Heretofore, so-called non-contact power feeding (also called wireless power feeding) technologies for transmitting power through space without the intermediary of metal contacts or the like have been studied.

As one non-contact power feeding technology, a magnetic field resonance (also called magnetic field resonant coupling or magnetic resonance) method is known (see Patent Document 1). With the magnetic field resonance method, resonant circuits that include a coil are respectively provided on a power transmission side and a power reception side, and a coupled magnetic field state in which energy transfer by magnetic field resonance is possible between the coil on the power transmission side and the coil on the power reception side is produced, by tuning the resonant frequencies of these resonant circuits. Power is thereby transmitted through space from the coil on the power transmission side to the coil on the power reception side. With non-contact power feeding by the magnetic field resonance method, it is possible to attain an energy transfer efficiency of around several tens of percent, and it is possible to comparatively increase the distance between the coil on the power transmission side and the coil on the power reception side. For example, in the case where each coil has a size of around several tens of centimeters, the distance between the coil on the power transmission side and the coil on the power reception side can be set from several tens of centimeters to one meter or more.

On the other hand, with the magnetic field resonance method, it is known that the energy transfer power amount decreases when the distance between the coil on the power transmission side and the coil on the power reception side approaches closer than an optimal distance (see Patent Document 2). This is due to the degree of coupling between the two coils changing according to the distance between the two coils, and the resonant frequency between the two coils changing. In the case where the distance between the two coils is appropriate, there is one resonant frequency between the two coils, and that resonant frequency is equal to the resonant frequency of the resonant circuits on the power transmission side and the power reception side, which is determined by the inductance of the coils and the electrostatic capacity of the capacitors. However, when the distance between the two coils shortens and the degree of coupling increases, two resonant frequencies appear between the two coils. One will be a higher frequency than the resonant frequency of the resonant circuits themselves, and the other will be a lower frequency than the resonant frequency of the resonant circuits themselves. The resonant frequency between the two coils thus no longer coincides with the resonant frequency of the resonant circuits themselves when the degree of coupling increases, and thus the energy transfer power amount decreases, since the resonance between the coils does not occur satisfactorily, even when alternating current (AC) power having the resonant frequency of the resonant circuits is supplied to the resonant circuit on the power transmission side.

In view of this, the power transmission device disclosed in Patent Document 2 has a power transmission coil that transmits, as magnetic field energy, power supplied from a power source unit to a power reception resonant coil that resonates at a resonant frequency that produces magnetic field resonance and whose resonant point differs from the power reception resonant coil. This power transmission device thereby enables transmission and reception of power between the power transmission coil and the power reception resonant coil, without utilizing magnetic field resonance.

### RELATED ART DOCUMENTS

### Patent Documents

Patent Document 1: JP 2009-501510T

Patent Document 2: WO 2011/064879

### SUMMARY OF THE INVENTION

### Problems to be Solved by the Invention

With the magnetic field resonance method, improvement in the energy transfer power amount is attained, by configuring the resonant frequencies between the coil on the power transmission side and the coil on the power reception side to be the same. However, with the technology disclosed in Patent Document 2, since the resonant point of the power transmission coil differs from the resonant point of the power reception resonant coil, there is a risk that the energy transfer power amount will decrease.

In view of this, one or more embodiments may provide a non-contact power feeding device that is able to suppress any decrease in the energy transfer power amount, even when the distance between the coil on the power transmission side and the coil on the power reception side changes.

### Means for Solving the Problems

As one mode, a non-contact power feeding device including a power transmission device and a power reception device having a receiving coil to which power is transmitted in a non-contact manner from the power transmission device is provided. In this non-contact power feeding device, the power transmission device includes a resonant circuit and a power supply circuit. The resonant circuit has a capacitor and a transmitting coil connected to one end of the capacitor and configured to perform power transmission with the receiving coil. Also, the power supply circuit is configured to supply AC power having an adjustable operating frequency to the resonant circuit. Furthermore, the power transmission device has a voltage detection circuit configured to detect an AC voltage applied to the transmitting coil and a control circuit configured to adjust the operating frequency of the AC power supplied from the power supply circuit in a direction in which the AC voltage increases.

In this non-contact power feeding device, it may be preferable that the control circuit of the power transmission device, in a case where the AC voltage applied to the transmitting coil after the operating frequency has been changed in one of a direction increasing the operating frequency and a direction decreasing the operating frequency is higher than the AC voltage applied to the transmitting coil before changing the operating frequency, further changes the operating frequency in the one direction, and, in a case where the AC voltage applied to the transmitting coil after changing the operating frequency is lower than the AC voltage applied to the transmitting coil before changing the operating frequency, changes the operating frequency in an opposite direction to the one direction.

In this case, it may be preferable that the control circuit has a memory configured to store a resonant frequency of the resonant circuit. Also, it may be preferable that the control circuit sets the operating frequency at a time of starting non-contact power feeding to the power reception device to the resonant frequency of the resonant circuit.

Also, in this non-contact power feeding device, it may be preferable that the power supply circuit of the power transmission device includes a direct current (DC) power source and two switching elements connected in series between a positive electrode side terminal and a negative electrode side terminal of the DC power source. In this case, it may be preferable that one end of the resonant circuit is connected between the two switching elements, and the other end of the resonant circuit is connected to the negative electrode side terminal. Also, it may be preferable that the control circuit switches the two switching elements on and off alternately with the operating frequency of the power supply circuit.

### Effects of the Invention

A non-contact power feeding device according to one or more embodiments achieves the effect of being able to suppress any decrease in the energy transfer power amount, even when the distance between the coil on the power transmission side and the coil on the power reception side changes.

### BRIEF DESCRIPTION OF THE DRAWINGS

FIG. 1 is a schematic configuration diagram illustrating a non-contact power feeding device according to one or more embodiments.

FIG. 2 is an equivalent circuit diagram illustrating a non-contact power feeding device.

FIG. 3 is a diagram illustrating an example of the frequency characteristics of impedance of an equivalent circuit, such as in FIG. 2.

### EMBODIMENTS OF THE INVENTION

Hereinafter, a non-contact power feeding device according to one or more embodiments will be described, with reference to the drawings. As described above, with non-contact power feeding that utilizes resonance between a coil on the power transmission side and a coil on the power reception side, the resonant frequency changes, according to the distance between the coil on the power transmission side (hereinafter called the transmitting coil), and the coil on the power reception side (hereinafter called the receiving coil). In view of this, this non-contact power feeding device measures the change in the AC voltage that is applied to the transmitting coil, while changing the operating frequency of the AC power supplied to the transmitting coil, during power supply. This non-contact power feeding device then changes the operating frequency of a power supply circuit that is supplied to the transmitting coil, that is, the operating frequency of the AC power that is supplied from the power supply circuit, in a direction in which the AC voltage increases, based on the above change in the AC voltage. This non-contact power feeding device thereby suppresses any decrease in the energy transfer power amount, by enabling AC power having an operating frequency near the resonant frequency to be supplied to the transmitting coil, regardless of the distance between the transmitting coil and the receiving coil.

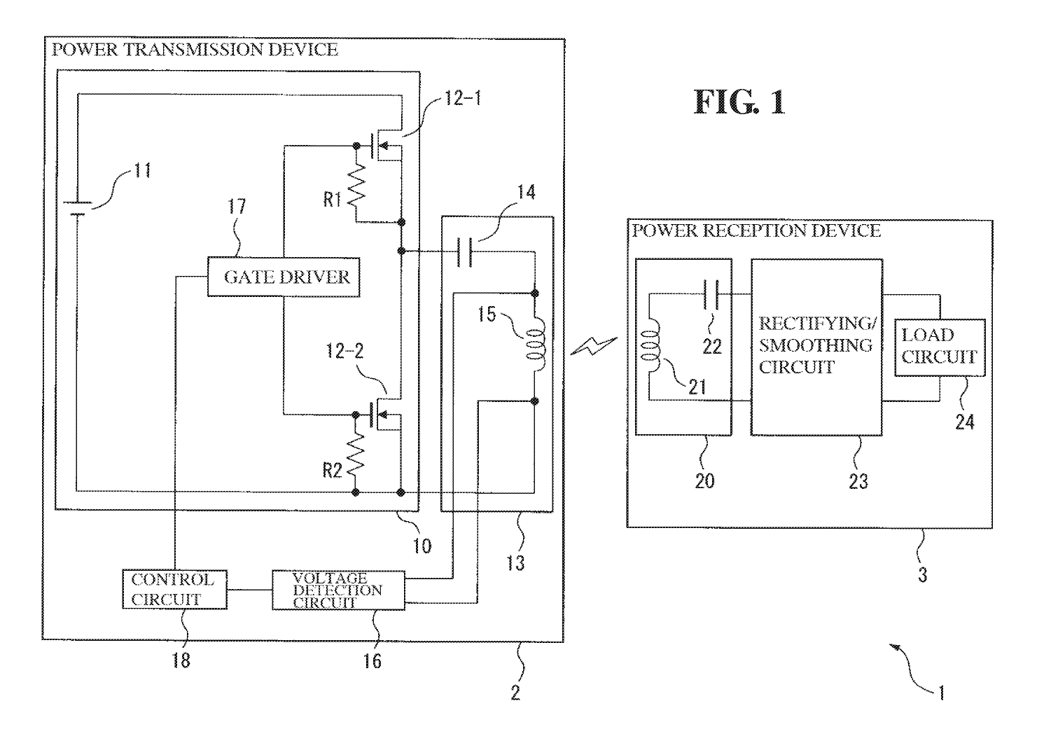

FIG. 1 is a schematic configuration diagram of the non-contact power feeding device according to one or more embodiments. As shown in FIG. 1, a non-contact power feeding device 1 has a power transmission device 2 and a power reception device 3 to which power is transmitted through space from the power transmission device 2. The power transmission device 2 has a power supply circuit 10, a resonant circuit 13 having a capacitor 14 and a transmitting coil 15, a voltage detection circuit 16, a gate driver 17, and a control circuit 18. On the other hand, the power reception device 3 has a resonant circuit 20 having a receiving coil 21 and a capacitor 22, a rectifying/smoothing circuit 23, and a load circuit 24.

First, the power transmission device 2 will be described.

The power supply circuit 10 supplies AC power having an adjustable operating frequency to the resonant circuit 13. For that purpose, the power supply circuit 10 has a DC power source 11 and two switching elements 12-1 and 12-2.

The DC power source 11 supplies DC power having a predetermined voltage. For that purpose, the DC power source 11 may, for example, have a battery. Alternatively, the DC power source 11 may be connected to a commercial AC power source, and have a smoothing capacitor and a full-wave rectifying circuit for converting AC power supplied from the AC power source into DC power.

The two switching elements 12-1 and 12-2 are connected in series between the positive electrode side terminal and the negative electrode side terminal of the DC power source 11. Also, in one or more embodiments, the switching element 12-1 is connected to the positive electrode side of the DC power source 11, whereas the switching element 12-2 is connected to the negative electrode side of the DC power source 11. The switching elements 12-1 and 12-2 can, for example, be configured as n-channel MOSFETs. The drain terminal of the switching element 12-1 is connected to the positive electrode side terminal of the DC power source 11, and the source terminal of the switching element 12-1 is connected to the drain terminal of the switching element 12-2. Also, the source terminal of the switching element 12-2 is connected to the negative electrode side terminal of the DC power source 11. Furthermore, the source terminal of the switching element 12-1 and the drain terminal of the switching element 12-2 are connected to one end of the transmitting coil 15 via the capacitor 14, and the source terminal of the switching element 12-2 is directly connected to the other end of the transmitting coil 15.

Also, the gate terminals of the switching elements 12-1 and 12-2 are connected to the control circuit 18 via the gate driver 17. Furthermore, the gate terminals of the switching elements 12-1 and 12-2 are respectively connected to the source terminal via resistors R1 and R2, in order to ensure that the switching elements will turn on when a voltage for turning on the switching elements is applied. The switching elements 12-1 and 12-2 are switched on and off alternately, by a control signal from the control circuit 18. The DC power supplied from the DC power source 11 is converted into AC power through charging and discharging by the capacitor 14, and the AC power is supplied to the resonant circuit 13 composed of the capacitor 14 and the transmitting coil 15.

The resonant circuit 13 is an LC resonant circuit that is formed by the capacitor 14 and the transmitting coil 15.The capacitor 14 is connected at one end to the source terminal of the switching element 12-1 and the drain terminal of the switching element 12-2, and is connected at the other end to the transmitting coil 15.

One end of the transmitting coil 15 is connected to the other end of the capacitor 14, and the other end of the transmitting coil 15 is connected to the negative electrode side terminal of the DC power source 11 and the source terminal of the switching element 12-2. The transmitting coil 15 then produces a magnetic field that depends on the current flowing through the transmitting coil 15 itself, using the AC power supplied from the power supply circuit 10. In the case where the distance between the transmitting coil 15 and the receiving coil 21 is short enough to enable resonance to occur, the transmitting coil 15 resonates with the receiving coil 21, and transmits power to the receiving coil 21 through space.

The voltage detection circuit 16 detects the AC voltage applied between both terminals of the transmitting coil 15, every predetermined period. Note that the predetermined period is, for example, set to be longer than a period corresponding to a smallest value envisaged for the operating frequency of the AC power that is supplied to the transmitting coil 15, such as 50 msec to 1 sec, for example. Also, the voltage detection circuit 16 measures the peak value or the effective value of the AC voltage, for example, as the AC voltage that is detected. The voltage detection circuit 16 then outputs a voltage detection signal representing the AC voltage to the control circuit 18. Thus, the voltage detection circuit 16 can be configured as any of various voltage detection circuits that are able to detect an AC voltage, for example.

The gate driver 17 receives a control signal for switching on/off of the switching elements 12-1 and 12-2 from the control circuit 18, and changes the voltage that is applied to the gate terminals of the switching elements 12-1 and 12-2 according to the control signal. That is, the gate driver 17, upon receiving a control signal for turning on the switching element 12-1, applies a relatively high voltage to the gate terminal of the switching element 12-1, such that the switching element 12-1 turns on, and the current from the DC power source 11 flows through the switching element 12-1. On the other hand, the gate driver 17, upon receiving a control signal for turning off the switching element 12-1, applies a relatively low voltage to the gate terminal of the switching element 12-1, such that the switching element 12-1 turns off, and the current from the DC power source 11 no longer flows through the switching element 12-1. The gate driver 17 also similarly controls the voltage that is applied to the gate terminal of the switching element 12-2.

The control circuit 18 has, for example, nonvolatile and volatile memory circuits, a computational circuit and an interface circuit for connecting to other circuits, and the operating frequency of the power supply circuit 10, that is, the operating frequency of the AC power that the power supply circuit 10 supplies to the resonant circuit 13, is adjusted according to the AC voltage applied to the transmitting coil 15 which is indicated by the voltage detection signal.

Thus, in one or more embodiments, the control circuit 18 controls the switching elements 12-1 and 12-2, such that the switching element 12-1 and the switching element 12-2 turn on alternately, and the time period during which the switching element 12-1 is on and the time period during which the switching element 12-2 is on within one period corresponding to the operating frequency are equal. Note that the control circuit 18 may provide dead time during which both switching elements are off, when switching on/off of the switching element 12-1 and the switching element 12-2, in order to prevent the switching element 12-1 and the switching element 12-2 turning on at the same time, and the DC power source 11 being short-circuited.

In one or more embodiments, the control circuit 18 changes the operating frequency, that is, the on/off switching period of the switching elements 12-1 and 12-2, in a direction in which the AC voltage that is applied to the transmitting coil 15 increases.

Note that control of the switching elements 12-1 and 12-2 by the control circuit 18 will be discussed in detail later.

Next, the power reception device 3 will be described.

The resonant circuit 20 is an LC resonant circuit consisting of the receiving coil 21 and the capacitor 22. The receiving coil 21 that is provided in the resonant circuit 20 is connected at one end to the capacitor 22, and is connected at the other end to the rectifying/smoothing circuit 23.

The receiving coil 21 resonates with the transmitting coil 15 and receives power from the transmitting coil 15, due to resonance occurring with the magnetic field produced by the AC current that flows to the transmitting coil 15 of the power transmission device 2. The receiving coil 21 then outputs received power to the rectifying/smoothing circuit 23 via the capacitor 22. Note that the number of turns of the receiving coil 21 and the number of turns of the transmitting coil 15 of the power transmission device 2 may be the same or may differ. Also, the inductance of the receiving coil 21 and the electrostatic capacity of the capacitor 22 are preferably set, such that the resonant frequency of the resonant circuit 20 and the resonant frequency of the resonant circuit 13 of the power transmission device 2 will be equal.

The capacitor 22 is connected at one end to the receiving coil 21, and is connected at the other end to the rectifying/smoothing circuit 23. The capacitor 22 then outputs power received by the receiving coil 21 to the rectifying/smoothing circuit 23.

The rectifying/smoothing circuit 23 rectifies and smoothes the power received using the receiving coil 21 and the capacitor 22, and converts the received power into DC power. The rectifying/smoothing circuit 23 then outputs the DC power to the load circuit 24. For that purpose, the rectifying/smoothing circuit 23 has, for example, a full-wave rectifying circuit and a smoothing capacitor.

Hereinafter, operations of the non-contact power feeding device 1 will be described in detail.

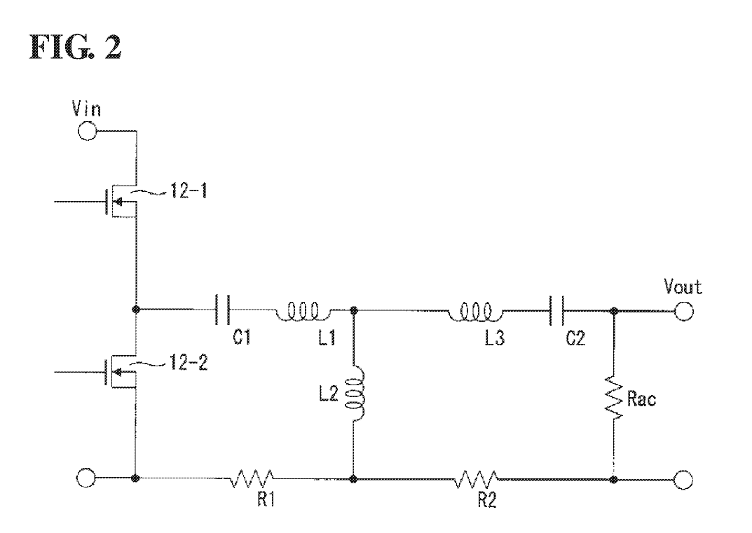

FIG. 2 is an equivalent circuit diagram of the non-contact power feeding device 1. Here, L₁ and L₃ are respectively the leakage inductances on the power transmission side and the power reception side, and L₂ is the mutual inductance. L₁=L₃=(1-k)L₀ and L₂=kL₀, where L₀ is the self-inductance of the transmitting coil 15 and the receiving coil 21, and k is the degree of coupling between the transmitting coil 15 and the receiving coil 21. For example, L₁=L₃=8.205 μH and L₂=22.3 μH when L₀=30.5 μH and k=0.731028. Generally, the degree of coupling k increases as the distance between the transmitting coil 15 and the receiving coil 21 narrows. In this case, a transmission matrix A(f), which is represented by F parameter analysis, is represented with the following equation.

$$\begin{matrix}Equation 1 & \\ A ( f ) := [ \begin{matrix}1 & \frac{1}{s ( f ) \cdot C 1} \\ 0 & 1\end{matrix} ] \cdot [ \begin{matrix}1 & s ( f ) \cdot L 1 + R 2 \\ 0 & 1\end{matrix} ] \cdot [ \begin{matrix}1 & 0 \\ \frac{1}{s ( f ) \cdot L 2} & 1\end{matrix} ] \cdot [ \begin{matrix}1 & s ( f ) \cdot L 3 + R 3 \\ 0 & 1\end{matrix} ] \cdot [ \begin{matrix}1 & \frac{1}{s ( f ) \cdot C 3} \\ 0 & 1\end{matrix} ] \cdot [ \begin{matrix}1 & 0 \\ \frac{1}{Rac} & 1\end{matrix} ] & ( 1 )\end{matrix}$$

Here, f is the operating frequency of the power supply circuit 10, s(f)=jω and ω=2Πf. C1 and C2 are respectively the electrostatic capacities on the power transmission side and the power reception side. R1 and R2 are the impedances on the power transmission side and the power reception side. Rac is the impedance of the load circuit.

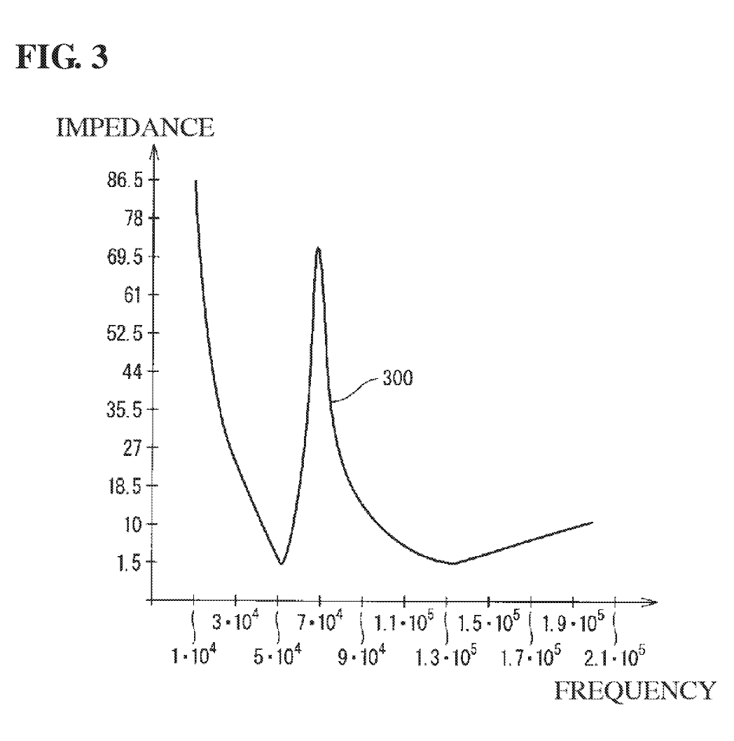

FIG. 3 is a diagram showing an example of the frequency characteristics of impedance of the equivalent circuit shown in FIG. 2. In FIG. 3, the horizontal axis represents frequency and the vertical axis represents impedance. Note that the impedance of the equivalent circuit is calculated as the absolute value of the ratio of the element on the upper left to the element on the lower left in the transmission matrix A(f) of equation (1), which is represented with two rows and two columns. A graph 300 represents the frequency characteristics of impedance. Note that the graph 300 was calculated based on equation (1), where L₀=30.5 μH and k=0.731028, and where C1=C2=180 nF and R1=R2=270 mΩ.

As shown in FIG. 3, in the case where the degree of coupling k is comparatively large, the frequency characteristics of impedance has two local minimum values. That is, the transmitting coil 15 and the receiving coil 21 resonate at two frequencies, and at each resonant frequency, the impedance is at a local minimum, that is, the energy transfer power amount is at a local maximum. Accordingly, as the operating frequency of AC power that is supplied to the resonant circuit 13 of the power transmission device 2 approaches one of the resonant frequencies, the impedance between the power transmission side and the power reception side will decrease, enabling the energy transfer power amount that is transmitted from the transmitting coil 15 to the receiving coil 21 to be increased. Thus, the AC voltage between both terminals of the receiving coil 21 on the power reception side also increases, as the operating frequency of AC power that is supplied to the resonant circuit 13 approaches one of the resonant frequencies.

Also, the relationship between the AC voltage on the power reception side and the AC voltage on the power transmission side is represented with the following relational equation.

$$\begin{matrix}Equation 2 & \\ {V}_{2} = \frac{{n}_{2}}{{n}_{1}} {kV}_{1} & ( 2 )\end{matrix}$$

Here, V1 is the AC voltage on the power transmission side, that is, the AC voltage that is applied to the transmitting coil 15, V2 is the AC voltage on the power reception side, that is, the AC voltage that is applied to the receiving coil 21. k is the degree of coupling. n1 and n2 are respectively the number of turns of the transmitting coil 15 and the number of turns of the receiving coil 21. As shown in equation (2), a stronger correlation relationship occurs between the voltage on the power reception side and the voltage on the power transmission side, as the degree of coupling increases. Thus, as long as the distance between the transmitting coil 15 and the receiving coil 21 is short and there is a certain degree of coupling, the AC voltage that is applied to the transmitting coil 15 on the power transmission side also increases, as the AC voltage of the receiving coil 21 on the power reception side increases, that is, as the power that can be extracted on the power reception side increases.

In view of this, the control circuit 18 of the power transmission device 2 changes the operating frequency of AC power supplied to the resonant circuit 13, that is, the on/off switching period of the switching elements 12-1 and 12-2, every given period, in a direction in which the AC voltage applied to the transmitting coil 15, which is indicated by the voltage detection signal, increases.

For example, the control circuit 18 saves the operating frequency and the value of the AC voltage that is applied to the transmitting coil 15 at a certain point in time to a memory circuit that is provided in the control circuit 18. The control circuit 18 then changes the operating frequency in a direction in which the operating frequency increases or decreases by a predetermined amount (e.g., 10 Hz to 100 Hz). The control circuit 18 then compares the latest value of the AC voltage, which is indicated by the voltage detection signal acquired from the voltage detection circuit 16 after changing the operating frequency, with the value of the previous AC voltage that is stored. In the case where the latest value of the AC voltage is higher than the previous value of the AC voltage, the control circuit 18 changes the operating frequency by a predetermined amount in the same direction as the direction of the previous change. For example, in the case where the operating frequency was increased at the time of the previous operating frequency change, and the latest value of the AC voltage is higher than the previous value of the AC voltage, the control circuit 18 further increases the operating frequency by a predetermined amount. Conversely, in the case where the latest value of the AC voltage is lower than the previous value of the AC voltage, the control circuit 18 changes the operating frequency by a predetermined amount in the opposite direction to the direction of the previous change. For example, in the case where the operating frequency was increased at the time of the previous operating frequency change, and the latest value of the AC voltage is lower than the previous value of the AC voltage, the control circuit 18 decreases the operating frequency by a predetermined amount. Note that the control circuit 18 may change the operating frequency in either direction, in the case where the latest value of the AC voltage is equal to the previous value of the AC voltage. The control circuit 18 is thereby able to approximate the operating frequency to one of the resonant frequencies between the transmitting coil 15 and the receiving coil 21.

Note that, the control circuit 18, in the case where the latest value of the AC voltage is greater than or equal to a predetermined threshold value, may stop adjustment of the operating frequency, and may keep the operating frequency constant after stopping adjustment. The control circuit 18 may then resume adjustment of the operating frequency, in the case where the latest value of the AC voltage falls to less than the predetermined threshold value, after stopping adjustment of the operating frequency.

Also, the control circuit 18 may change the operating frequency to be higher or may change the operating frequency to be lower, at the time of changing the initial operating frequency after starting power feeding.

Also, in the case where the transmitting coil 15 and the receiving coil 21 are separated to a certain extent, the number of resonant frequencies resulting from magnetic resonance between the transmitting coil 15 and the receiving coil 21 will be one, and that resonant frequency will be equal to the resonant frequency of the resonant circuit 13 itself. That one resonant frequency is included between the two resonant frequencies that appear in the case where the distance between the transmitting coil 15 and the receiving coil 21 is short. In view of this, the resonant frequency of the resonant circuit 13 itself may be stored in advance in the memory circuit of the control circuit 18, and the control circuit 18 may set the operating frequency at the time of starting power supply to the resonant frequency of the resonant circuit 13 itself. Alternatively, the control circuit 18 may store the operating frequency at the time when power supply was last ended in the memory circuit, and the stored operating frequency may be used as the operating frequency at the time when power supply is next started. By setting the operating frequency at the time when power supply is started in this way, the control circuit 18 is able to shorten the time needed for the operating frequency to approach one of the resonant frequencies resulting from the magnetic resonance between the transmitting coil 15 and the receiving coil 21.

Note that the lower limit and upper limit of the operating frequency may be set in advance. The control circuit 18 may then adjust the operating frequency between the lower limit and upper limit of the operating frequency. In this case, for example, the lower limit and the upper limit of the operating frequency are respectively set to a lower limit and an upper limit envisaged for the resonant frequency resulting from magnetic resonance between the transmitting coil 15 and the receiving coil 21.

Also, the control circuit 18 need not change the operating frequency, in the case where the latest value of the AC voltage, which is indicated by the voltage detection signal acquired from the voltage detection circuit 16, is greater than or equal to a predetermined threshold value. Furthermore, the control circuit 18 may also decrease the amount of change in the operating frequency, as the absolute value of the difference between the latest value of the AC voltage and the previous value of the AC voltage decreases.

As has been described above, this non-contact power feeding device monitors the AC voltage that is applied to the transmitting coil, in the power transmission device that transmits power in a non-contact manner to the power reception device, and adjusts the operating frequency of the AC power that is supplied to the resonant circuit including the transmitting coil in a direction in which that AC voltage increases. This non-contact power feeding device is thereby able to approximate the operating frequency to the resonant frequency between the transmitting coil and the receiving coil, regardless of the distance between the two coils, thus enabling any decrease in the energy transfer power amount to be suppressed. Also, this non-contact power feeding device does not need to investigate the distance between the power transmission device and the power reception device or the positional relationship thereof, and can thus be simplified, enabling miniaturization and reduction in manufacturing costs as a result.

Note that, according to a variation, the voltage detection circuit 16 may detect the AC voltage that is applied between both terminals of the capacitor 14. Because the capacitor 14 and the transmitting coil 15 form an LC resonant circuit, the phase of the AC voltage that is applied to the capacitor 14 and the phase of the AC voltage that is applied to the transmitting coil 15 are shifted by 90 degrees from each other, and thus the AC voltage that is applied to the capacitor 14 also increases, as the AC voltage that is applied to the transmitting coil 15 increases. Also, the peak value of the AC voltage that is applied to the transmitting coil 15 is equal to the peak value of the AC voltage that is applied to the capacitor 14. Accordingly, the voltage detection circuit 16 is able to indirectly detect the AC voltage that is applied to the transmitting coil 15, by detecting the AC voltage that is applied to the capacitor 14.

Note that, in this case, in order to facilitate detection of the AC voltage that is applied to the capacitor 14, the capacitor 14 may be connected between one end of the transmitting coil 15 and both the source terminal of the switching element 12-2 and the negative electrode side terminal of the DC power source 11. The other end of the transmitting coil 15 may then be directly connected to the source terminal of the switching element 12-1 and the drain terminal of the switching element 12-2.

Furthermore, in the power transmission device 2, the power supply circuit that supplies AC power to the resonant circuit 13 may have a different circuit configuration from the above one or more embodiments, as long as the circuit is able to variably adjust the operating frequency.

In this way, a person skilled in the art is able to make various changes in accordance with the mode that is carried out, within the scope of the invention.

### INDEX TO THE REFERENCE NUMERALS

1 Non-contact power supply device

2 Power transmission device

10 Power supply circuit

11 DC power source

12-1, 12-2 Switching element

13 Resonant circuit

14 Capacitor

15 Transmitting coil

16 Voltage detection circuit

17 Gate driver

18 Control circuit

3 Power reception device

20 Resonant circuit

21 Receiving coil

22 Capacitor

23 Rectifying/smoothing circuit

24 Load circuit

1. A non-contact power feeding device comprising a power transmission device and a power reception device having a receiving coil to which power is transmitted in a non-contact manner from the power transmission device,
the power transmission device including:
a resonant circuit having a capacitor and a transmitting coil connected to one end of the capacitor and configured to perform power transmission with the receiving coil;
a power supply circuit configured to supply AC power having an adjustable operating frequency to the resonant circuit;
a voltage detection circuit configured to detect an AC voltage applied to the transmitting coil; and
a control circuit configured to adjust the operating frequency of the AC power supplied from the power supply circuit in a direction in which the AC voltage increases.

2. The non-contact power feeding device according to claim 1,
wherein the control circuit, in a case where the AC voltage after the operating frequency has been changed in one of a direction increasing the operating frequency and a direction decreasing the operating frequency is higher than the AC voltage before changing the operating frequency, further changes the operating frequency in the one direction, and, in a case where the AC voltage after changing the operating frequency is lower than the AC voltage before changing the operating frequency, changes the operating frequency in an opposite direction to the one direction.

3. The non-contact power feeding device according to claim 2,
wherein the control circuit has a memory configured to store a resonant frequency of the resonant circuit, and
the control circuit sets the operating frequency at a time of starting non-contact power feeding to the power reception device to the resonant frequency of the resonant circuit.

4. The non-contact power feeding device according to claim 1,
wherein the power supply circuit includes:
a DC power source; and
two switching elements connected in series between a positive electrode side terminal and a negative electrode side terminal of the DC power source,
wherein one end of the resonant circuit is connected between the two switching elements, and the other end of the resonant circuit is connected to the negative electrode side terminal, and
the control circuit switches the two switching elements on and off alternately with the operating frequency.

5. The non-contact power feeding device according to claim 2,
wherein the power supply circuit includes:
a DC power source; and
two switching elements connected in series between a positive electrode side terminal and a negative electrode side terminal of the DC power source,
wherein one end of the resonant circuit is connected between the two switching elements, and the other end of the resonant circuit is connected to the negative electrode side terminal, and
the control circuit switches the two switching elements on and off alternately with the operating frequency.

6. The non-contact power feeding device according to claim 3,
wherein the power supply circuit includes:
a DC power source; and
two switching elements connected in series between a positive electrode side terminal and a negative electrode side terminal of the DC power source,
wherein one end of the resonant circuit is connected between the two switching elements, and the other end of the resonant circuit is connected to the negative electrode side terminal, and
the control circuit switches the two switching elements on and off alternately with the operating frequency.
